(19) United States
(12) Patent Application Publication
(10) Pub. No.: US 2026/0162112 A1
(43) Pub. Date: Jun. 11, 2026

(54) SYSTEM AND METHOD FOR EXPENDITURE AUTHORISATION AND RECORDAL

(71) Applicant: Dillon GRANT, Carrum Downs, Victoria (AU)

(72) Inventors: Dillon GRANT, Carrum Downs (AU); Alahna WHITE, Carrum Downs (AU)

(21) Appl. No.: 18/707,480

(22) PCT Filed: Nov. 3, 2022
(86) PCT No.: PCT/AU2022/051318

§ 371 Date: May 3, 2024

(30) Foreign Application Priority Data
Nov. 3, 2021 (AU) 2021903509

(51) Int. Cl. G06Q 20/40; G06Q 20/38

(52) U.S. Cl. CPC G06Q 20/40145; G06Q 20/389

(57) ABSTRACT

A method of recording online expenditures, using an Internet of Things (IoT) device, includes, receiving, using a communications device, a request to effect an online purchase using an IoT device of the user. The communications device processes the user's biometric identifier to confirm the user's identity. The IoT device captures and causes acceptance of the user's biometric indicator to enable the user for online purchases. Confirmation that the user has provided a biometric indicator to the IoT device is received. The IoT device transmits the biometric indicator for user identity verification and user authorisation of the online purchase, and the requested online purchase is allowed. Document(s) of the online purchase are received and, using character recognition technique(s), the document(s) are processed to identify expenditures associated with the online purchase effected by the IoT device. The online purchase expenditure data is extracted from the documents pertaining to the online purchase expenditure.

### FIELD OF THE INVENTION

The present invention relates to a system and method for interfacing with Internet of Things (IoT) devices as may be utilised by users for effecting online purchases and recording documents/data relating to such purchases for user review.

### BACKGROUND OF THE INVENTION

The incurrence of online expenditure by users, e.g. for the purchase of goods or services, has become ubiquitous in modern times, and online retail is now arguably more popular than traditional retail (e.g. attendance at “bricks and mortar” stores). The means by which online expenditure may occur has also evolved, with new technologies now available to facilitate such purchases, including the use of home-based Internet of Things (IoT) devices that collect and transmit data across a wireless network, and which are capable of prompting users to make purchases based on their daily requirements or based on data that is collected from sensors positioned around the home.

Homes that are automated (also known as “smart homes”) typically include a plurality of IoT devices that are inter-connected. Such devices are operated by embedded systems with software and communications modules that enable the exchanging of data with other devices and systems over a wireless network. One of the functions that has been facilitated by IoT devices used in the home is the purchase of goods and services online. Such devices may authenticate a user prior to purchase by authenticating a biometric of the user, e.g. by recognising the user's voice or palm print, with no passcode or additional biometric information required. Such devices have evolved such that they are considered sufficiently smart to know with relatively high certainty who is issuing instructions to make an online purchase through voice recognition.

Examples of home-based IoT devices include Google Nest® and Amazon Echo®, which enable authentication through the operation of dedicated software including Google Assistant® and Alexa® respectively.

In order for such devices to function as intended, they require fifth generation (5G) wireless technology, which is being installed presently throughout the world, with sixth generation (6G) wireless technology expected to launch commercially thereafter. Wireless networks such as 5G (and eventually 6G) give rise to higher speeds, lower latency, and increased bandwidth as compared with their predecessors, and are necessary to support the ever expanding number of IoT devices.

A problem that arises from the relative ease with which users can command online purchases using home-based IoT devices, such as Google Nest® and Amazon Echo®, is that the method by which purchase transaction data is recorded, and hence the ability for users to monitor/control their spending, is inadequate. It is envisaged that such devices will increasingly prompt users to make online purchases based upon home-based IoT devices sensing the need for such purchases to replenish stock (e.g. prompting a user to purchase pet food based upon a sensor detecting that stored pet food in the premises is low). Given the ease with which users are able to effect online purchases using IoT devices, e.g. based upon a voice command by the user, users can easily lose track of expenditure.

The Applicant has recognised a need for improvement relating to the recordal of purchase transaction data with respect to purchases that are made according to the use of IoT devices and the prompting of a time automation device with subsequent provision of authority from users to effect online purchases using such IoT devices.

The computer-implemented system and method of the present invention seeks to address the above identified problems or at least provide an alternative solution to same.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method of recordal of online expenditure effected using an Internet of Things (IoT) device, the method including, receiving, by one or more processors, from a data communications device associated with a user, a request for authority to effect an online purchase utilising an IoT device associated with the user, the data communications device operable to process a biometric identifier of the user, to confirm the identity of the user, the IoT device operable to capture a biometric indicator of the user and enable the user to effect one or more online purchases, and the IoT device operable to cause acceptance of the biometric indicator from the user to effect an online purchase, receiving, by the one or more processors, confirmation that the user has provided a biometric indicator to the IoT device to effect an online purchase, the IoT device transmitting the biometric indicator for verification of the user's identity and authorisation for the user to effect the online purchase, causing, by the one or more processors, the requested online purchase to be effected, receiving, by the one or more processors, one or more documents associated with the effected online purchase, processing, by the one or more processors, using one or more character recognition techniques, the one or more documents to identify those documents pertaining to expenditure associated with the online purchase effected by the IoT device; and extracting, by one or more processors, from the documents identified as pertaining to expenditure associated with the online purchase, expenditure data associated with the online purchase.

In an embodiment, the method further includes, storing, in a database that includes a data structure, expenditure data associated with the user, the expenditure data including, the expenditure data associated with the online purchase, and expenditure data extracted from additional documents relating to other sources of expenditure associated with the user.

In an embodiment, the method further includes, storing, in the database, income data including income data extracted from additional documents relating to sources of income associated with the user.

In an embodiment, the method further includes, indexing, by the one or more processors, the stored income and expenditure data.

In an embodiment, the method further includes, predicting, by the one or more processors, utilising a machine learning model and based on the indexed data, future online expenditure that will be incurred by the user on a regular or semi-regular basis.

In an embodiment, the method further includes, generating, by the one or more processors, a report associated with the expenditure of the user, the report including an indication regarding one or more of, historical online expenditure incurred by the user according to the expenditure data; and predicted future online expenditure by the user according to the analysis utilising the machine learning model.

In an embodiment, the report includes an invoice payment schedule for the user that takes into account the predicted future online expenditure and the frequency of the predicted future online expenditure such that the user may review likely future payments that will be required in view of the historical and predicted future online expenditure of the user.

In an embodiment, the report indicates whether, based on the income data associated with the user, the user is likely to have sufficient funds to accommodate the invoice payment schedule.

In an embodiment, providing authority for the user to effect online purchases utilising the IoT device is further based upon one or more of, expenditure data associated with the user, historical and/or predicted future online expenditure, and income data associated with the user.

In an embodiment, where the expenditure data associated with the user, the historical and/or predicted future online expenditure, and/or the income data associated with the user do not satisfy minimum predetermined thresholds, the user is denied authority to effect the online purchase.

In an embodiment, the method further includes, receiving, by the one or more processors, from a requestor, a request for review or audit of the income and/or expenditure data associated with the user, and extracting, utilising the data structure, the income and/or expenditure data based upon the request; and providing, by the one or more processors, to the requestor, the extracted income and/or expenditure data.

In an embodiment, the requestor is an adviser to the user, such as an Accountant, or a Government agency.

In an embodiment, the one or more processors are processors operable on one or more of, the data communications device, the IoT device, and an external server.

In an embodiment, each of the data communications device, IoT device and external server are communicatively coupled via a wireless network such that each component is capable of exchanging data via the wireless network.

In an embodiment, the wireless network is a fifth generation (5G) network.

In an embodiment, the wireless network is a sixth generation (6G) network.

In a second aspect, the present invention provides a system including, one or more processors operable to, receive, from a data communications device associated with a user, a request for authority to effect an online purchase utilising an IoT device associated with the user, the data communications device operable to process a biometric indicator of the user to confirm the identity of the user, the IoT device operable to capture a biometric indicator of the user and enable the user to effect one or more online purchases, and the IoT device operable to cause acceptance of the biometric indicator from the user to effect an online purchase, receive confirmation that the user has provided a biometric indicator to the IoT device to effect an online purchase, the IoT device transmitting the biometric indicator to the data communications device for verification of the user's identity and authorisation for the user to effect the online purchase, cause the requested online purchase to be effected, receive one or more documents associated with the effected online purchase effected by the IoT device, process, using one or more character recognition techniques, the one or more documents to identify those documents pertaining to expenditure associated with the online purchase effected by the IoT device; and extract, from the documents identified as pertaining to expenditure associated with the online purchase, expenditure data associated with the online purchase.

In a third aspect, the present invention provides a computer-readable medium having a plurality of instructions executable by one or more processors to, receive, from a data communications device associated with a user, a request for authority to effect an online purchase utilising an IoT device associated with the user, the data communications device operable to process a biometric indicator of the user to confirm the identity of the user, the IoT device operable to capture a biometric indicator of the user and to enable the user to effect one or more online purchases, and the IoT device operable to cause acceptance of the biometric indicator from the user to effect the online purchase; receive confirmation that the user has provided a biometric indicator to the IoT device to effect an online purchase, the IoT device transmitting the biometric indicator to the date communications device for verification of the user's identity and authorisation for the user to effect the online purchase, cause the requested online purchase to be effected, receive one or more documents associated with the effected online purchase, process, using one or more character recognition techniques, the one or more documents to identify those documents pertaining to expenditure associated with the online purchase effected by the IoT device; and extract, from the documents identified as pertaining to expenditure associated with the online purchase, expenditure data associated with the online purchase.

### BRIEF DESCRIPTION OF THE DRAWINGS

Features of the present disclosure are illustrated by way of example and not limited in the following Figure(s), in which like numerals indicate like elements, in which:

FIG. 1 provides an overview of a system according to an embodiment of the present invention showing, particularly, the interaction between various system components;

FIG. 2 illustrates an exemplary diagram associated with the purchasing system, budget monitoring system and IoT device of the system illustrated in FIG. 1;

FIG. 3 illustrates an exemplary flow diagram of a process that enables a user to request a purchase utilising the IoT device;

FIG. 4 illustrates an exemplary flow diagram of a process that enables the identify of the user to be verified through capture of a biometric indicator of the user;

FIG. 5 illustrates an exemplary flow diagram of a process that enables an order relating to the purchase to be placed with an online retailer, and delivery of the goods purchased; and

FIG. 6 illustrates an exemplary flow diagram of a process that enables the user to be provided with notifications regarding expenditure and spending habits.

### DETAILED DESCRIPTION OF EMBODIMENT(S) OF THE INVENTION

For illustrative purposes, the present disclosure is described by referring to embodiment(s) thereof. In the following description, numerous specific details are set forth to provide a better understanding of the present disclosure. It will be readily apparent that the current disclosure can be practiced without limitation to the specific details. In other instances, some methods and structures have not been described in detail to avoid obscuring the present disclosure.

The present invention relates to at least a computer-implemented system and method for expenditure authorisation and recordal. In an embodiment, the system and method include use of an Internet of Things (IoT) device (10) operable to effect online purchases using an associated purchasing system (20), and a budget monitoring system (30) with which the the IoT device (10) is in communication. The budget monitoring system (30) may be in the form of a server that maintains one or more processors and/or databases for performing tasks, including receiving a request from the IoT device (10) (or any device linked to the IoT device (10) such as a smartphone associated with user (100)), for authority to effect the online purchase. The IoT (or associated) device (10) is operable to capture and process a biometric identifier (140) of the user (100), and on the basis of confirming the identity of the user (100), accepts the biometric indicator (140) to effect the online purchase through the purchasing system (20).

The IoT device (10) can be any known device capable of receiving and actioning commands, including voice commands for example, from a user. The device may also operate any suitable virtual assistant software (examples of known virtual assistants including Google's Assist, Amazon's Alexa, and Apple's Siri). The purchasing system (20) could be part of the virtual assistant software, or could involve independent hardware/software (e.g. a remote system providing purchasing functionality which is accessed by the virtual assistant software).

Once a purchase has been effected, one or more documents associated with the effected purchase are received by the budget monitoring system (30) and processed, including using one or more character recognition techniques, to identify those documents pertaining to expenditure associated with the online purchase effected by the IoT device (10). Expenditure data associated with the online purchase may then be extracted from the documents accordingly. The extracted expenditure data may then be utilised by the system (30) to provide reports, notifications and alerts to the user, as described in greater detail below.

In this way, the solution assists users to monitor and control their spending when using IoT devices to make purchases for them. The solution uses an intelligent budget monitoring system (30) that can utilise the data to predict spending and identify trends. Where the spending trend relates to an “overspend” likely to result in a problem for the user (e.g. where expenditure exceeds a predetermined threshold for a particular period of time), the system may cause the IoT device (10) (or associated device) to notify or alert the user so that the user can adjust their spending.

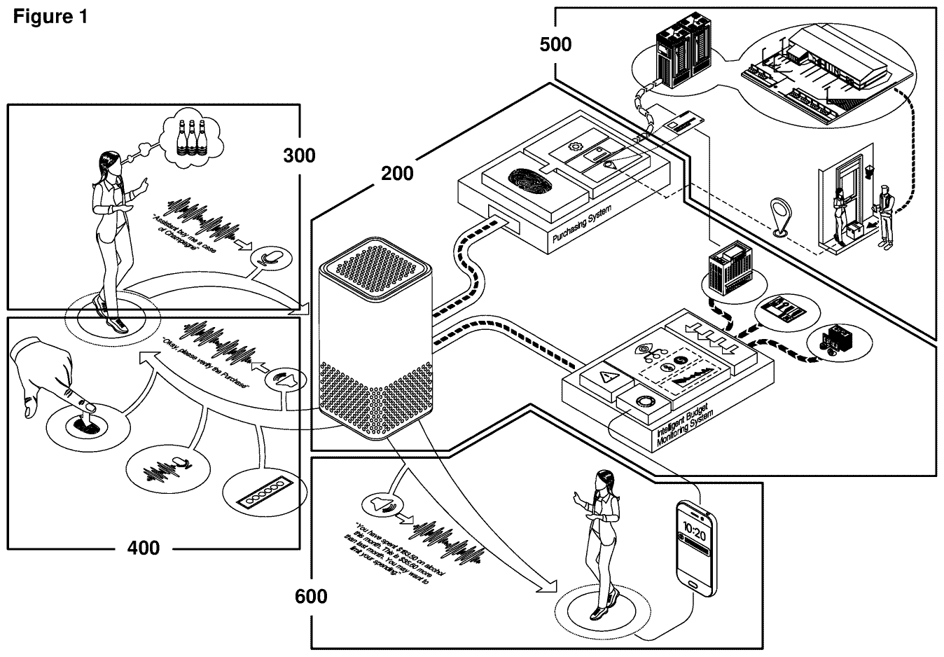

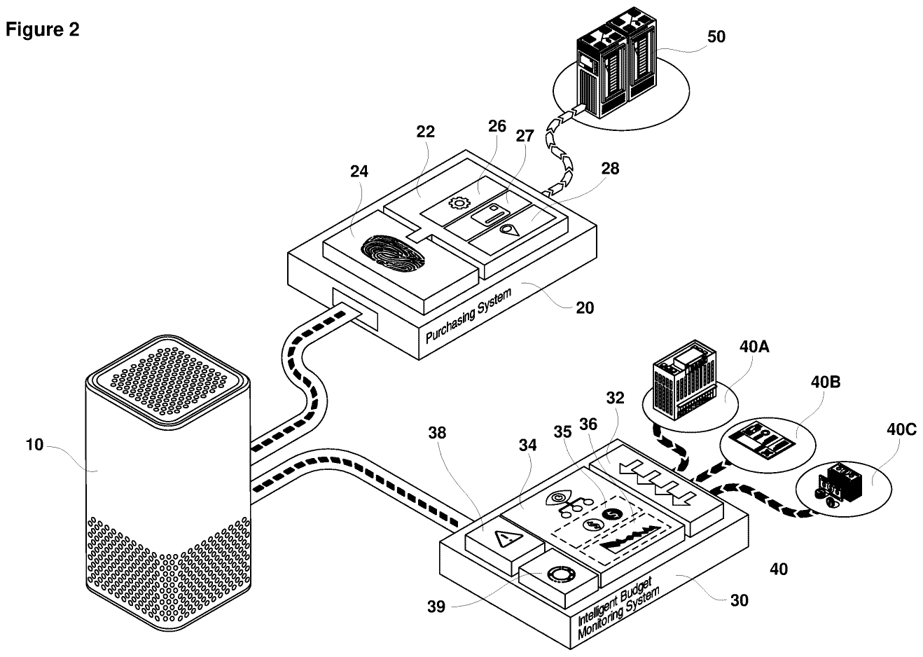

FIG. 1 is divided into segments which are further expanded in FIGS. 2 to 6. In particular, segment 200 of FIG. 1 shows the budget monitoring system (30) with which a software application operating on a data communication device associated with user (100) may communicate. It will be apparent to skilled readers that the software application may be a mobile application or a web application and that, similarly, the data communication device utilised by a user (100) may be a mobile device or computer device. The budget monitoring system (30), IoT device (10) and associated purchasing system (20) are additionally detailed in FIG. 2, and the skilled person will appreciate that the steps described herein, as executed by the IoT device (10) and/or budget monitoring system (30), may be facilitated by the software application operating on a user device.

Different arrangements are possible in this regard, but according to a particular implementation of the present invention, the budget monitoring system (30), which may be a server, is programmed to provide all of the functions described herein, particularly where such functions cannot be provided locally on the IoT device (10) or any associated user devices.

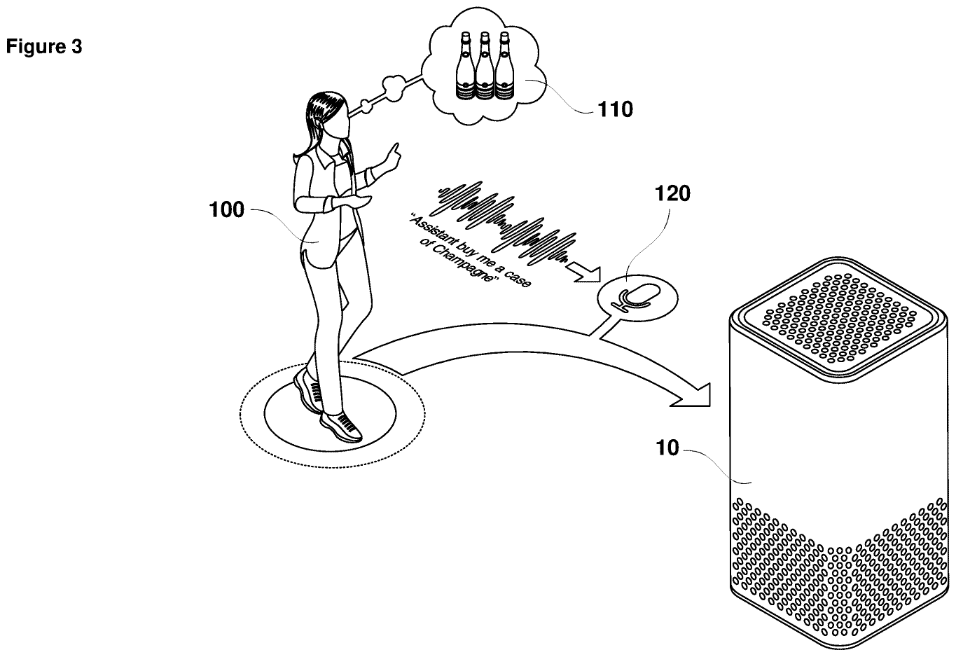

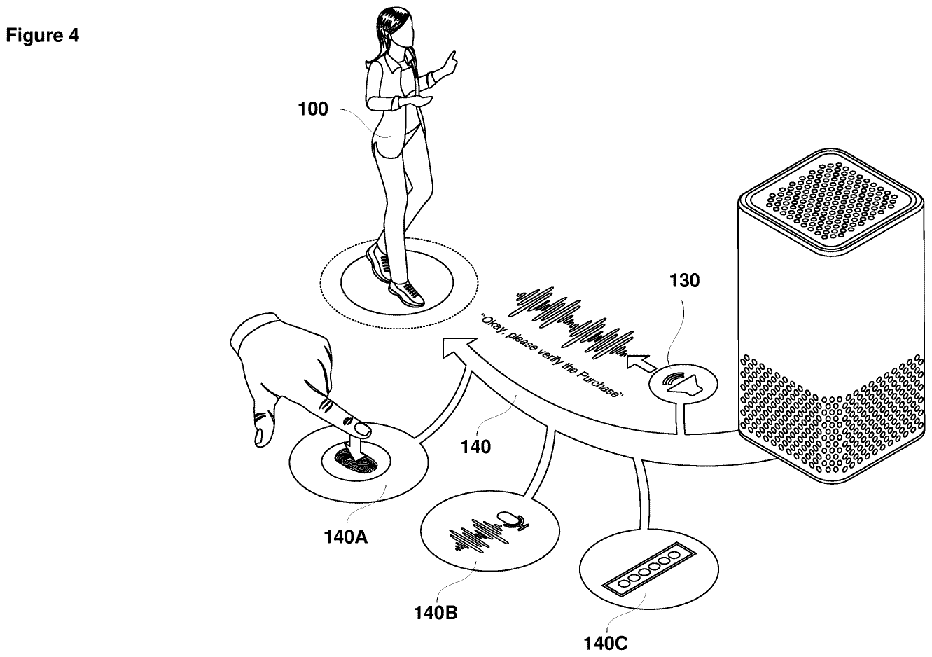

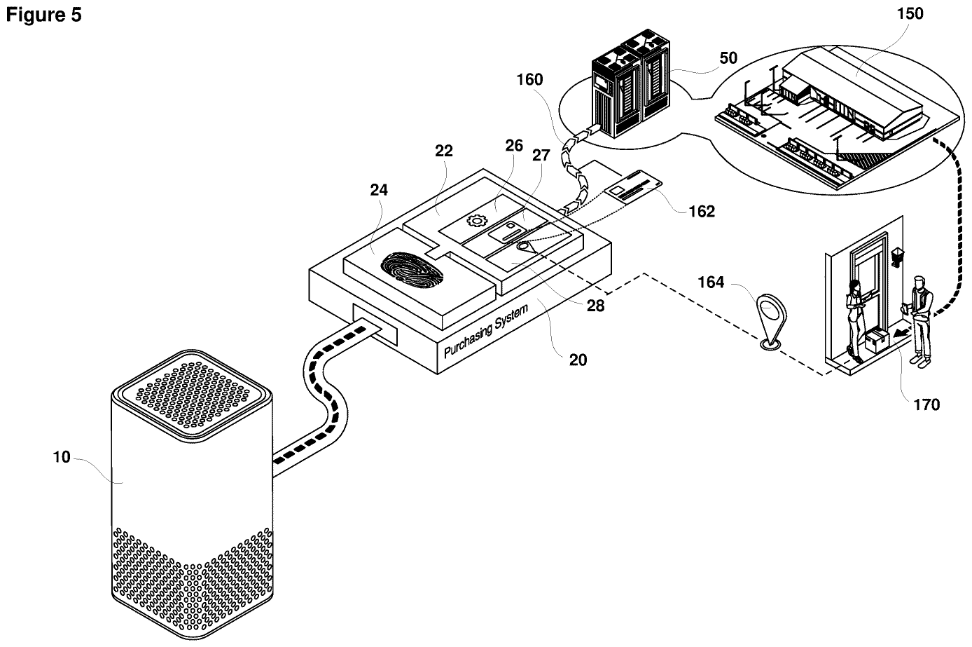

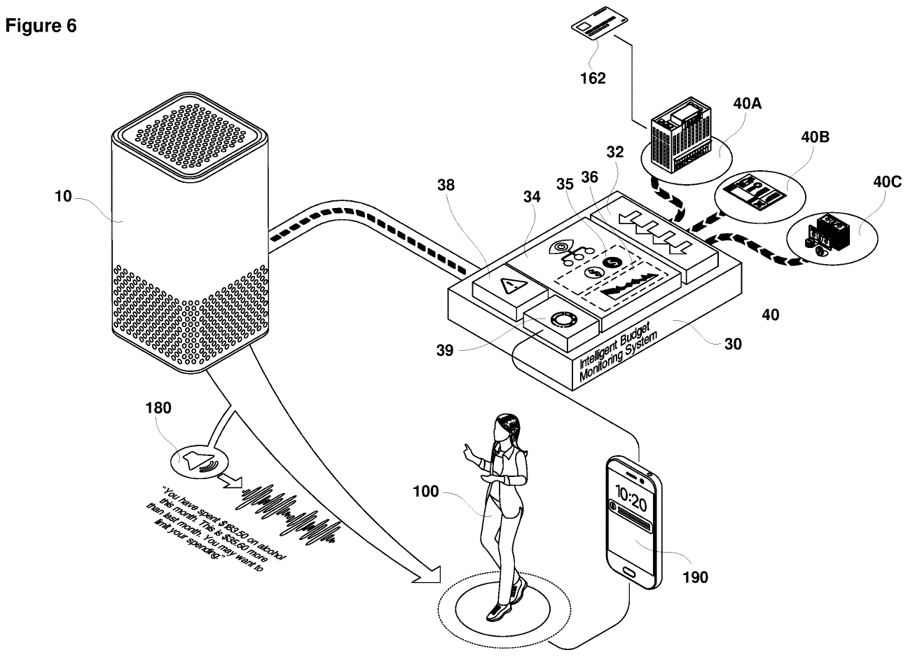

Segment 300 of FIG. 1 shows the user (100) requesting the purchase of a product (110) using IoT device (10), as further detailed in FIG. 3. Segment 400 of FIG. 1 illustrates how the identity of the user (100) may be verified (140) by the IoT device (10), as detailed in FIG. 4. Segment 500 of FIG. 1 illustrates how the IoT device (10) may communicate with the purchasing system (20) to effect the purchase of the product (110) from a retailer (150) and cause the product to be delivered to the user (100), as detailed in FIG. 5. Segment 600 of FIG. 1 illustrates how the budget monitoring system (30) receives information relating to expenditure of the user (100) and issues notifications (including alerts 180) to the user, as further detailed in FIG. 6.

As mentioned above, FIG. 2 shows in greater detail segment 200 of FIG. 1, and in particular, FIG. 2 shows all three components that may be utilised to effect and report upon purchases initiated by user (100), i.e. the IoT device (10), the purchasing component (20) and the budget monitoring system (30).

The purchasing system (20) may operate one or more computer processors and maintain one or more databases to enable the following functionality and/or storage:
Purchasing engine (22) for accepting purchasing requests from the user (100) and then based on the user's shopping preferences (26) will source, order and pay (27) for the product(s);
Verification engine (24) for verifying the identity of the user (100) after the user (100) has provided a biometric identifier (140) to IoT device (10) (as described in greater detail below with reference to FIG. 4);
Shopping preferences repository (26) storing shopping preferences of users (100), e.g. preferred stores, online retailers, brands, product price ranges, etc;
Payment details repository (27) storing information relating to the preferred payment methods of users, such as credit card or online payment providers such as Paypal;
Shipping details repository (28) storing information relating to shipping locations to which users (100) prefer their purchased products to be delivered.

The budget monitoring system (30) may operate one or more computer processors and maintain one or more databases to enable the following functionality and/or storage;

Data feed (32) which enables the system (30) to receive data from a plurality of different sources associated with the user including, for example, vendors (150) from whom the user (100) has purchased a product, incomes sources, financial institutions (including bank and credit card service providers), utility service providers and government authorities);
Expenditure monitor (34) responsible for processing documents received via data feed (32) using one or more character recognition techniques to identify those documents pertaining to income and expenditure, identify documents that pertain to particular categories of income/expenditure (e.g. documents that relate to expenditure relating to product purchases made through purchasing system (20), and extracting expenditure data (examples of categories may include “essential expenditure”, “non-essential expenditure”, “bills”, “groceries”, “dining out”, etc, or any combination thereof);
Expenditure category database (35) in the form of a data structure that stores the various documents and income/expenditure data extracted therefrom in accordance with the income/expenditure category;
Trend analysis (36) for analysing the extracted data and determining patterns or trends in the data as compared with predetermined thresholds (e.g. over the course of a particular month, expenditure data may indicate that purchases effected through IoT device (10) have exceeded a particular expenditure threshold);
Notification functionality (38) which generates notifications, alerts and/or recommendations to users (100) in accordance with the results of trend analysis (36) (e.g. alerting the user (100) that purchases effected through the IoT device (10) have exceeded the monthly threshold, and providing a recommendation to avoid further “non-essential” purchases for the month);
Report generation functionality (39) for generating reports and the like for sending to the user (100) and other interested parties by text message, push notification, email, etc (examples of reports include total income v income expenditure, income by category, expenditure by category, trend and forecast details).

Also shown in FIG. 2 is the ability of the budget monitoring system (30) to communicate with the various sources of financial information for the user (100), including a financial institution (40A), utility providers (40B) and income providers (e.g. employer of user (100)) (40C), as described above. FIG. 2 also depicts that purchasing system (20) is configured to communicate with computer hardware various retailers (150), and in this regard, such communications may occur via an application programming interface (API), network interface, or similar.

The skilled addressee will appreciate that the purchasing system (20) may be used to effect purchases on behalf of the user (100), whilst the budget monitoring system (30) monitors the user's financial situation and provides information and feedback (including alerts and recommendations) in substantially real-time and utilising up to date data relating to the user's income and expenditure. As previously described, systems (20) and (30) may be part of the virtual assistant software or part of a service providing the functionality which is accessed by the virtual assistant. In the embodiment shown, the virtual assistant software is integrated into the IoT device (190) which is in the form of a smart speaker.

The purchasing engine (22) receives purchase requests from the user (100) and based on shopping preferences (26) may source, order and pay for the goods. The purchasing system (20) may also verify that the user is authorised to make the purchase through the virtual assistant, as described below. In this regard, the verification engine (24) may determine who is authorised and verify the user (100) using one or more verification methods.

The budget monitoring system (30) may categorise all income and expenditure details extracted from documents sourced by the system (30), and identify purchases by category (including a category relating to purchases effected by the virtual assistant purchasing system). In this regard, the system (30) may utilise a database that includes a data structure to index such data and facilitate the efficient extraction thereof. The budget monitoring system (10) may monitor the overall expenditure and spending trends and providing alerts and reports to the user (100). It may report to the user (100) their financial position and in particular, provide alerts to the user (100) before the user effects any additional purchases using their Virtual assistant.

FIG. 3 shows in greater detail segment 300 of FIG. 1 and, in particular, the steps associated with a user (100) providing a voice command (120) to the IoT device (10) to purchase a product (110) (in the example shown, a case of champagne, i.e. “Assistant buy me a case of Champagne”). Before the user can initiate such commands, it will be understood that the user will necessarily be required to install and configure the IoT device, including potentially linking the IoT device (10) with other devices around the home as well as the user's smart phone.

To ensure that the request is from a user associated with the device (10) (e.g. the owner or an authorised user of the device (10)), the purchase request (120) needs to be verified using a supported verification technique. FIG. 4 shows in greater detail segment 400 of FIG. 1 and, in particular, the issuance of a verification instruction (140) from the IoT device (10) “Okay, please verify the Purchase”. This instruction (140) invites the user (100) to provide an identifier (140), which may be in the form of a biometric identifier 140A (such as finger print, palm print, or facial recognition) or 140B (voice recognition), or another form of identifier 140C (such as pin, password or secret phrase). Such identifiers can be provided directly to the IoT device (10), where the IoT device is adequately equipped to process such identifiers. Alternatively, the identifier could be provided via another device such as the user's smart phone linked to the IoT device (10).

The identifier may then be used to confirm the user's identity (i.e. verify the identifier as being associated with the user (100)), and this can be achieved using the verification engine (24) associated with the purchasing system (20), as described above, or any other verification technique. Once the user's identity has been verified, the IoT device (10) can accept the indicator from the user (10) to effect the online purchase.

There may be additional authorisation methods utilised that affect whether the user (100) will be allowed to initiate an online purchase. For example, providing authority to the user (100) may also be based upon one or more of expenditure data associated with the user, historical and/or predicted future online expenditure, and income data associated with the user. For example, where the expenditure data associated with the user, the historical and/or predicted future online expenditure, and/or the income data associated with the user do not satisfy minimum predetermined thresholds, the user may be denied authority to effect the online purchase.

FIG. 5 shows in greater detail segment 500 of FIG. 1 and, in particular, the order being placed with the relevant online retailer (150), as well as the delivery of the product (110) to the user (100). In one example, the purchasing system (20) may interface (160) with the user's preferred online retailer (150) (via an Application Programming Interface (API) or similar) in order to effect the purchase. The payment may be settled using the user's preferred payment method (162), such as credit card or via online payment provider such as Paypal. The online retailer (150) may then deliver the product (110) to the user (100) in accordance with a preferred delivery details (location, etc) (164) specified by the user (100), thereby fulfilling (170) the order.

FIG. 6 shows in greater detail segment 600 of FIG. 1 and, in particular, the retrieval of income and expenditure documents from one or more of the financial institution (40A), utility providers (40B) and income providers (e.g. employer of user (100)) (40C) associated with user (100), and the processing of such documents to identify documents pertaining to particular income/expenditure categories (e.g. expenditure associated with the online purchases effected by the IoT device (10). Once certain documents are identified, then useful data may be extracted as required, i.e. based upon the notifications, reports, alerts, etc, requested by the user (100). For example, the user (100) may prefer that he/she be notified by the Virtual Assistant regarding their financial position before they make additional purchases. Such alerts may be more specific and include a recommendation, as shown in FIG. 6, where the IoT device provides an alert (180) the user (100) that “You have spent $183.50 on alcohol this month. This is $35.60 more than last month. You may want to limit your spending”. FIG. 6 also shows an example of an expenditure report (160) that may be automatically generated based upon the categorised data, upon request. Such reports may be in the form of text messages, push notifications or emails, and may display income and expenditure according to particular categories.

The reports may also provide trend and forecast details. In this regard, the system (30) may be further configured to predict future expenditure that will be incurred by the user (100) on a regular or semi-regular basis through use of a machine learning model and the indexed data relating to expenditure by the user (100). The report may include an invoice payment schedule for the user (100) that takes into account the predicted future expenditure and the frequency of the predicted future expenditure such that the user may review likely future payments that will be required in view of the historical and predicted future expenditure of the user. Such reports may also indicate whether, based on the income data associated with the user, the user (100) is likely to have sufficient funds to accommodate the invoice payment schedule.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A computer-implemented method of recordal of online expenditure effected using an Internet of Things (IOT) device, the method comprising:
receiving, by one or more processors, from a data communications device associated with a user, a request for authority to effect an online purchase utilising an IoT device associated with the user,
the data communications device operable to process a biometric identifier of the user, to confirm the identity of the user,
the IoT device operable to capture a biometric indicator of the user and enable the user to effect one or more online purchases, and
the IoT device operable to cause acceptance of the biometric indicator from the user to effect the online purchase;
receiving, by the one or more processors, confirmation that the user has provided a biometric indicator to the IoT device to effect an online purchase,
the IoT device transmitting the biometric indicator for verification of the user's identity and authorisation for the user to effect the online purchase;
causing, by the one or more processors, the requested online purchase to be effected;
receiving, by the one or more processors, one or more documents associated with the effected online purchase;
processing, by the one or more processors, using one or more character recognition techniques, the one or more documents to identify those documents pertaining to expenditure associated with the online purchase effected by the IoT device;
extracting, by one or more processors, from the documents identified as pertaining to expenditure associated with the online purchase, expenditure data associated with the online purchase;
storing, in a database that comprises a data structure, the expenditure data associated with the user, the expenditure data comprising, the expenditure data associated with the online purchase, and expenditure data extracted from additional documents relating to other sources of expenditure associated with the user;
storing, in the database, income data comprising income data extracted from additional documents relating to sources of income associated with the user;
indexing, by the one or more processors, the stored income and expenditure data; and
predicting, by the one or more processors, utilising a machine learning model and the indexed data, future online expenditure that will likely be incurred by the user on a regular or semi-regular basis.

2. The computer-implemented method of claim 1, the method further comprising generating, by the one or more processors, a report associated with the expenditure of the user, the report comprising_an indication regarding one or more of, historical online expenditure incurred by the user according to the expenditure data, and predicted future online expenditure by the user according to the analysis utilising the machine learning model.

3. The computer-implemented method of claim 2, wherein the report comprises an invoice payment schedule for the user that takes into account the predicted future online expenditure and the frequency of the predicted future online expenditure such that the user may review likely future payments that will be required in view of the historical and predicted future online expenditure of the user.

4. The computer-implemented method of claim 2, wherein the report indicates whether, based on the income data associated with the user, the user is likely to have sufficient funds to accommodate the invoice payment schedule.

5. The computer-implemented method of claim 1, wherein providing authority for the user to effect online purchases utilising the IoT device is further based upon one or more of, expenditure data associated with the user, historical and/or predicted future online expenditure, and income data associated with the user.

6. The computer-implemented method of claim 5, wherein the expenditure data associated with the user, the historical and/or predicted future online expenditure, and/or the income data associated with the user do not satisfy minimum predetermined thresholds, the user is denied authority to effect the online purchase.

7. The computer-implemented method of claim 1, wherein the method further comprises, receiving, by the one or more processors, from a requestor, a request for review or audit of the income and/or expenditure data associated with the user, and extracting, utilising the data structure, the income and/or expenditure data based upon the request, and providing, by the one or more processors, to the requestor, the extracted income and/or expenditure data.

8. The computer-implemented method of claim 1, wherein the one or more processors are processors operable on one or more of, the data communications device, the IoT device, and an external server.

9. The computer-implemented method of claim 1, wherein each of the data communications device, IoT device and external server are communicatively coupled via a wireless network such that each component is capable of exchanging data via the wireless network.

10. A system comprising:
one or more processors operable to:
receive, from a data communications device associated with a user, a request for authority to effect an online purchase utilising an IoT device associated with the user,
the data communications device operable to process a biometric indicator of the user to confirm the identity of the user,
the IoT device operable to capture a biometric indicator of the user and enable the user to effect one or more online purchases, and
the IoT device operable to cause acceptance of the biometric indicator from the user to effect the online purchase;
receive confirmation that the user has provided a biometric indicator to the IoT device to effect an online purchase;
the IoT device transmitting the biometric indicator for verification of the user's identity and authorisation for the user to effect the online purchase;
cause the requested online purchase to be effected;
receive one or more documents associated with the online purchase effected by the IoT device;
process, using one or more character recognition techniques, the one or more documents to identify those documents pertaining to expenditure associated with the online purchase effected by the IoT device;
extract, from the documents identified as pertaining to expenditure associated with the online purchase, expenditure data associated with the online purchase;
store, in a database that includes a data structure, the expenditure data associated with the user, the expenditure data comprising, the expenditure data associated with the online purchase, and expenditure data extracted from additional documents relating to other sources of expenditure associated with the user;
store, in the database, income data comprising income data extracted from additional documents relating to sources of income associated with the user;
index, by the one or more processors, the stored income and expenditure data; and
predict, by the one or more processors, utilising a machine learning model and the indexed data, future online expenditure that will likely be incurred by the user on a regular or semi-regular basis.

11. The system of claim 10, the one or more processors further operable to generate a report associated with the expenditure of the user, the report comprising an indication regarding one or more of, historical online expenditure incurred by the user according to the expenditure data, and predicted future online expenditure by the user according to the analysis utilising the machine learning model.

12. The system of of claim 10, the one or more processors further operable to provide authority for the user to effect online purchases utilising the IoT device based upon one or more of, expenditure data associated with the user, historical and/or predicted future online expenditure, and income data associated with the user.

13. The system of of claim 10, the one or more processors further operable to receive, from a requestor, a request for review or audit of the income and/or expenditure data associated with the user, and extracting, utilising the data structure, the income and/or expenditure data based upon the request; and providing, by the one or more processors, to the requestor, the extracted income and/or expenditure data.

14. The system of claim 10, wherein the one or more processors are operable on one or more of, the data communications device, the IoT device, and an external server.

15. The system of claim 10, wherein each of the data communications device, IoT device and external server are communicatively coupled via a wireless network such that each component is capable of exchanging data via the wireless network.

16. A computer-readable medium having a plurality of instructions executable by one or more processors to:
receive, from a data communications device associated with a user, a request for authority to effect an online purchase utilising an IoT device associated with the user,
the data communications device operable to process a biometric indicator of the user to confirm the identity of the user,
the IoT device operable to capture a biometric indicator of the user and enable the user to effect one or more online purchases, and
the IoT device operable to cause acceptance of the biometric indicator to the IoT device to effect the online purchase;
receive confirmation that the user has provided a biometric indicator to the IoT device to effect an online purchase,
the IoT device transmitting the biometric indicator for verification of the user's identity and authorisation for the user to effect the online purchase;
cause the requested online purchase to be effected;
receive one or more documents associated with the effected online purchase;
process, using one or more character recognition techniques, the one or more documents to identify those documents pertaining to expenditure associated with the online purchase effected by the IoT device;
extract, from the documents identified as pertaining to expenditure associated with the online purchase, expenditure data associated with the online purchase;
store, in a database that comprises a data structure, the expenditure data associated with the user, the expenditure data comprising, the expenditure data associated with the online purchase, and expenditure data extracted from additional documents relating to other sources of expenditure associated with the user;
store, in the database, income data comprising income data extracted from additional documents relating to sources of income associated with the user;
index, by the one or more processors, the stored income and expenditure data; and
predict, by the one or more processors, utilising a machine learning model and the indexed data, future online expenditure that will likely be incurred by the user on a regular or semi-regular basis.
